(19) United States
(12) Patent Application Publication
(10) Pub. No.: US 2020/0413229 A1
(43) Pub. Date: Dec. 31, 2020

(54) MULTICAST CONTROL DEVICE, MULTICAST CONTROL METHOD, AND NON-TRANSITORY COMPUTER READABLE MEDIUM

(71) Applicant: NEC CORPORATION, Tokyo (JP)

(72) Inventors: Akira KAMEI, Tokyo (JP); Torn YAMADA, Tokyo (JP); Kyoji HIRATA, Tokyo (JP); Masahiro SERIZAWA, Tokyo (JP); Satoshi HASEGAWA, Tokyo (JP); Masashi SHIMOMA, Tokyo (JP)

(73) Assignee: NEC CORPORATION, Tokyo (JP)

(21) Appl. No.: 16/980,963

(22) PCT Filed: Feb. 8, 2019
(86) PCT No.: PCT/JP2019/004533

§ 371 Date: Sep. 15, 2020

(30) Foreign Application Priority Data
Mar. 15, 2018 (JP) 2018-050090

(51) Int. Cl. H04W 4/06; H04W 4/70; H04W 48/06; H04W 8/20

(52) U.S. Cl. CPC H04W 4/06; H04W 8/20; H04W 48/06; H04W 4/70

(57) ABSTRACT

A multicast control device capable of reducing the processing load of a core network device that occurs when a large number of communication devices use a multicast service is provided. A multicast control device (10) according to the present disclosure includes a communication unit (13) configured to receive a joining request message from a communication terminal to join a multicast service, a determination unit (11) configured to determine whether the number of communication terminals already joining the multicast service reaches a predetermined threshold, and a management unit (12) configured to reject joining of the communication terminal having sent the joining request message to the multicast service when it is determined that the number of communication terminals already joining the multicast service reaches the predetermined threshold.

### TECHNICAL FIELD

The present invention relates to a multicast control device, a multicast control method, and a program.

### BACKGROUND ART

A rapid increase in IoT (Internet of Things) devices connected to a network is forecast in years to come. It is therefore important to efficiently perform firmware update or security software upgrade for IoT devices.

In order to efficiently perform firmware update or the like, data distribution using multicast communication to a plurality of IoT devices is studied, for example. Non Patent Literature 1 discloses specifications related to MBMS (Multimedia Broadcast and Multicast Service) defined by 3GPP (3rd Generation Partnership Project). The MBMS is a service related to broadcast and multicast performed in a mobile network. To be specific, Non Patent Literature 1 discloses processing in each phase defined in a multicast mode.

### CITATION LIST

### Non Patent Literature

NPL1: 3GPP TS 23.246 V15.0.0 (2017-12)

### SUMMARY OF INVENTION

### Technical Problem

When an IoT device joins a multicast service using the MBMS, information about this IoT device is registered in a core network device. Thus, if a large number of IoT devices simultaneously join a multicast service, the amount of information about the IoT devices registered in a core network device increases. In other words, if a large number of IoT devices simultaneously join a multicast service, there is a problem that the processing load for registering information about the IoT devices in a core network device increases.

In view of the foregoing, an object of the present disclosure is to provide a multicast control device, a multicast control method, and a program capable of reducing the processing load of a core network device that occurs when a large number of communication devices use a multicast service.

### Solution to Problem

A multicast control device according to a first aspect of the present disclosure includes a communication unit configured to receive a joining request message from a communication terminal to join a multicast service, a determination unit configured to determine whether the number of communication terminals already joining the multicast service reaches a predetermined threshold, and a management unit configured to reject joining of the communication terminal having sent the joining request message to the multicast service when it is determined that the number of communication terminals already joining the multicast service reaches the predetermined threshold.

A multicast control method according to a second aspect of the present disclosure includes receiving a joining request message from a communication terminal to join a multicast service, determining whether the number of communication terminals already joining the multicast service reaches a predetermined threshold, and rejecting joining of the communication terminal having sent the joining request message to the multicast service when it is determined that the number of communication terminals already joining the multicast service reaches the predetermined threshold.

A program according to a third aspect of the present disclosure causes a computer to perform receiving a joining request message from a communication terminal to join a multicast service, determining whether the number of communication terminals already joining the multicast service reaches a predetermined threshold, and rejecting joining of the communication terminal having sent the joining request message to the multicast service when it is determined that the number of communication terminals already joining the multicast service reaches the predetermined threshold.

### Advantageous Effects of Invention

According to the present invention, there are provided a multicast control device, a multicast control method, and a program capable of reducing the processing load of a core network device that occurs when a large number of communication devices use a multicast service.

### BRIEF DESCRIPTION OF DRAWINGS

FIG. 1 is a block diagram of a multicast control device according to a first example embodiment.

FIG. 2 is a block diagram of a communication system according to a second example embodiment.

FIG. 3 is a block diagram of a BM-SC according to the second example embodiment.

FIG. 4 is a view showing the overview of a multicast session control process performed in the BM-SC according to the second example embodiment.

FIG. 5 is a view showing the flow of a determination process as to whether or not to allow joining a multicast service in the BM-SC according to the second example embodiment.

FIG. 6 is a view showing the flow of a determination process as to whether or not to allow joining a multicast service in the BM-SC according to a third example embodiment.

### DESCRIPTION OF EMBODIMENTS

### First Example Embodiment

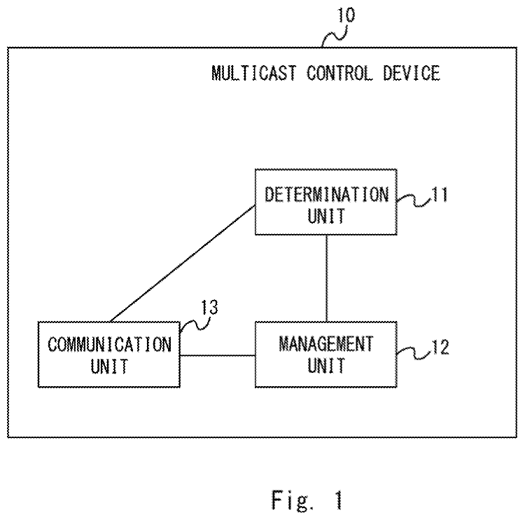

Example embodiments of the present invention are described hereinafter with reference to the drawings. First, a configuration example of a multicast control device 10 according to a first example embodiment is described with reference to FIG. 1. The multicast control device 10 may be a computer device that operates when a processor executes a program stored in a memory. The multicast control device 10 may be a core network device or a base station whose functions or operations are defined by 3GPP, for example.

The multicast control device 10 includes a determination unit 11, a management unit 12, and a communication unit 13. The determination unit 11, the management unit 12 and the communication unit 13 may be software or module whose processing is performed when a processor executes a program stored in a memory. Alternatively, the determination unit 11, the management unit 12 and the communication unit 13 may be hardware such as a chip or a circuit.

The communication unit 13 receives a joining request message from a communication terminal to join a multicast service. The communication terminal may be a cellular phone terminal, a smart phone terminal, an IoT terminal, or an MTC (Machine Type Communication) terminal or the like. The communication terminal may be a computer device that operates when a processor executes a program stored in a memory. Further, the communication terminal may be a UE (User Equipment), which is a general term for communication terminals in 3GPP.

The multicast service is a service that simultaneously distributes data to a plurality of communication terminals that are joining this multicast service. The multicast service may be MBMS (Multimedia Broadcast and Multicast Service) defined by 3GPP, for example. Further, the multicast service is implemented by using an MBMS bearer service and an MBMS user service.

The joining request message may be sent as user data or may be sent as control data. The user data may be called U(User)-Plane data. Alternatively, the user data may be called application data. The control data may be called C(Control)-Plane data.

The determination unit 11 determines whether the number of communication terminals already joining the multicast service reaches a predetermined threshold or not. The predetermined threshold may be a value entered by an administrator who administrates the multicast control device 10 or the like. Further, the predetermined threshold may be changed depending on the type of data to be distributed by the multicast service. The data may be data required for the update of firmware, OS (Operating System) and so on of each communication terminal, for example. Alternatively, the data may be data required for the update of an application such as security software.

When it is determined that the number of communication terminals already joining the multicast service reaches a predetermined threshold, the management unit 12 rejects the joining of the communication terminal that has sent the joining request message to the multicast service. The management unit 12 may store information about the communication terminals that are joining the multicast service. Alternatively, the information about the communication terminals that are joining the multicast service may be stored in another management device or the like. To reject the joining may be to discard the joining request message received from the communication terminal, for example.

As described above, the multicast control device 10 can reject the joining of a new communication terminal to a multicast service when the number of communication terminals already joining the multicast service reaches a predetermined threshold. This prevents an excessive increase in processing load related to the registration of communication terminals or the like even when a large number of communication terminals simultaneously request to join a multicast service.

### Second Example Embodiment

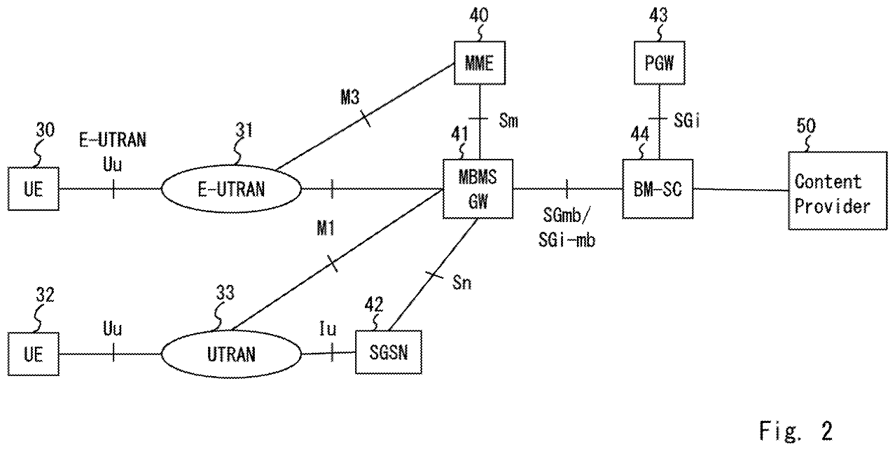

A configuration example of a communication system according to a second example embodiment is described hereinafter with reference to FIG. 2. The communication system in FIG. 2 shows an MBMS architecture in 3GPP.

The communication system in FIG. 2 includes a UE (User Equipment) 30, an E-UTRAN (Evolved-Universal Mobile Telecommunications System Terrestrial Radio Access Network) 31, a UE 32, UTRAN 33, an MME (Mobility Management Entity) 40, an MBMS-GW (MBMS-Gateway) 41, an SGSN (Serving General Packet Radio Service Support Node) 42, a PGW 43, a BM-SC (Broadcast Multicast Service Centre) entity 44 (which is referred to hereinafter as BM-SC 44), and a Content Provider 50. The Content Provider 50 shows an external server device. The component other than the Content Provider 50 configuring the communication system in FIG. 2 configures an EPS (Evolved Packet System). The UE may be replaced with a MS (Mobile Station).

The E-UTRAN 31 is a RAN that uses LTE (Long Term Evolution) as a wireless access system. The UE 30 is a wireless terminal that performs wireless communication using the LTE. The UTRAN 33 is a RAN that uses a 3G wireless system as a wireless access system. The UE 32 is a wireless terminal that performs wireless communication using the 3G wireless system.

The MME 40 and the SGSN 42 are node devices that perform session management and mobility management related to UEs. The MBMS-GW 41 is a gateway that distributes data by using broadcast communication to the UE 30 and the UE 32 through the E-UTRAN 31 and the UTRAN 33. The BM-SC 44 transmits content data sent from the Content Provider 50 to the MBMS-GW 41.

An E-UTRAN Uu reference point is defined between the UE 30 and the E-UTRAN 31. A Uu reference point is defined between the UE 32 and the UTRAN 33. An M3 reference point is defined between the E-UTRAN 31 and the MME 40. An Iu reference point is defined between the UTRAN 33 and the SGSN 42. An M1 reference point is defined between the E-UTRAN 31, the UTRAN 33 and the MBMS-GW 41. An Sm reference point is defined between the MME 40 and the MBMS-GW 41. An Sn reference point is defined between the SGSN 42 and the MBMS-GW 41. SGmb and SGi-mb reference points are defined between the MBMS-GW 41 and the BM-SC 44. An SGi reference point is defined between the BM-SC 44 and the PGW 43.

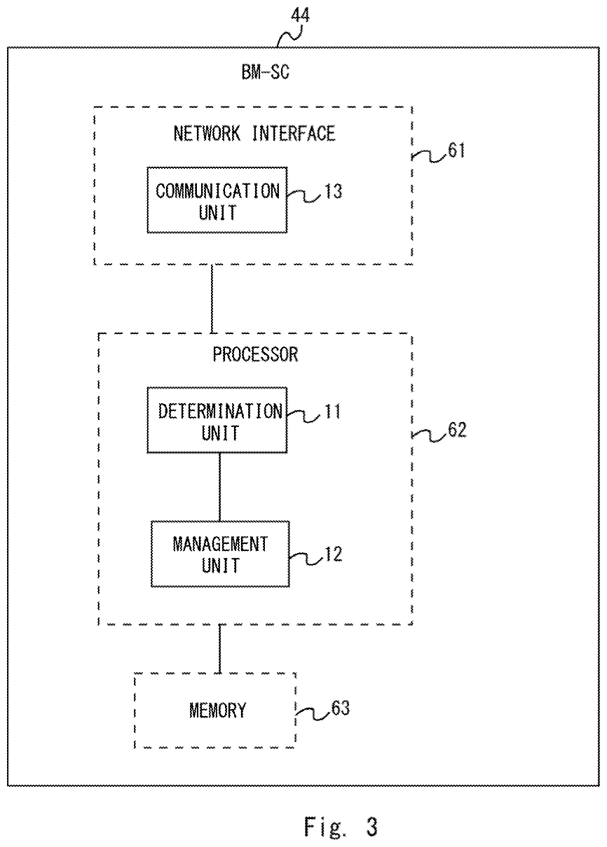

A configuration example of the BM-SC 44 according to the second example embodiment is described hereinafter with reference to FIG. 3. The BM-SC 44 includes a network interface 61, a processor 62, and a memory 63. The network interface 61 may include a baseband processor that performs digital baseband signal processing. Alternatively, the network interface 61 may include a network interface card (NIC) compliant with IEEE 802.3 series. The network interface 61 is used to perform the functions or processing in the communication unit 13 of FIG. 1.

The processor 62 reads software (computer program) from the memory 63 and performs processing which is described hereinafter with reference to flowcharts and the like. The processor 62 may be a microprocessor, an MPU (Micro Processing Unit) or a CPU (Central Processing Unit), for example. The processor 62 may include a plurality of processors.

The memory 63 is a combination of a volatile memory and a nonvolatile memory. The memory 63 may include a storage that is placed apart from the processor 62. In this case, the processor 62 may access the memory 63 through an I/O interface, which is not shown. The processor 62 is used to perform the functions or processing in the determination unit 11 and the management unit 12 of FIG. 1.

The memory 63 is used to store software or a group of software modules. The processor 62 reads and runs the software or the group of software modules from the memory 63.

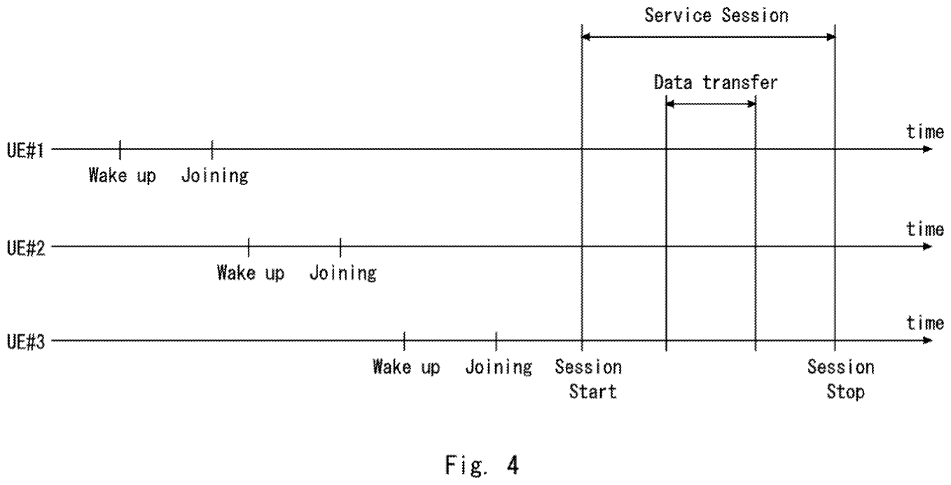

The overview of a multicast session control process performed in the BM-SC 44 is described hereinafter with reference to FIG. 4.

The horizontal axis of FIG. 4 indicates the passage of time. Wake Up indicates timing when each UE starts receiving data in DRX (Discontinuous Reception) or eDRX (extended DRX). In other words, Wake Up indicates timing to start discontinuous reception. A period of time during which a UE does not receive data may be called a sleep time. eDRX has a longer sleep time than DRX. Thus, a UE that uses eDRX achieves lower power consumption a UE that uses DRX.

Joining indicates timing when each UE joins a multicast service. For example, timing when an application related to a multicast service is started may be timing of Joining. Alternatively, Joining may be timing that is predetermined in each UE as timing to join a multicast service. The timing predetermined as timing to join a multicast service may be set as several seconds or several minutes after Wake Up, for example.

Session Start indicates timing when a multicast session starts. Session Stop indicates timing when a multicast session stops. A period of time from Session Start to Session Stop is Service Session. Data transfer indicates a period of time during which data is distributed to each UE. Data transfer is included in Service Session. For example, it is assumed that update data required for each UE to update an application or the like is distributed in Data transfer. Further, a period of time from Session Start to Data transfer may be a preparation period before the start of data distribution.

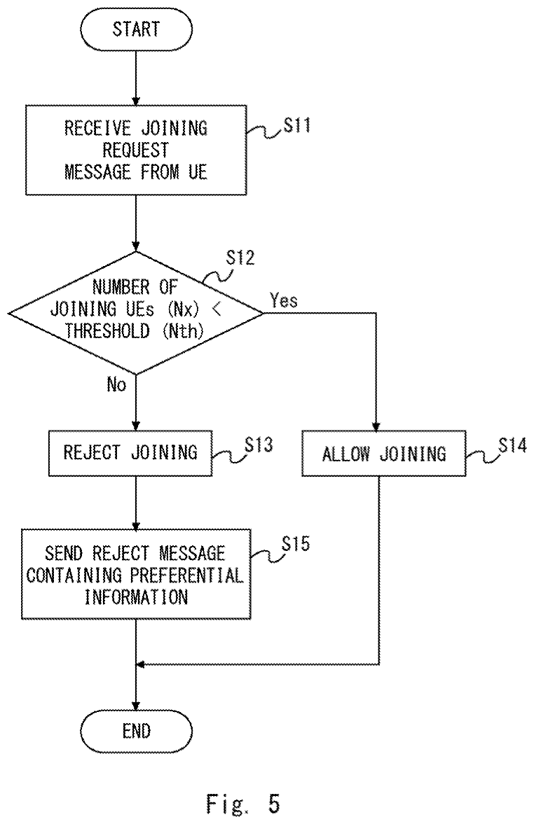

The flow of a determination process as to whether or not to allow joining a multicast service in the BM-SC 44 according to the second example embodiment is described hereinafter with reference to FIG. 5.

First, the communication unit 13 receives a joining request message that requests joining a multicast service from the UE 30 (S11). The joining request message is transmitted to the BM-SC 44 through the MBMS-GW 41, for example.

Next, the determination unit 11 determines whether the number (Nx) of UEs already joining the multicast service reaches a predetermined threshold (Nth) or not (S12). The number of UEs already joining the multicast service is the number of UEs that is already “Joining” the multicast service. The threshold (Nth) may be the maximum number of devices allowed to connect in a cell formed by a base station located in the E-UTRAN 31 or the UTRAN 33, for example.

For example, the Joining UE may send a message indicating Joining to the BM-SC 44 by using control data or user data. The determination unit 11 or the management unit 12 may manage a list of UEs that have joined the multicast service based on the message received from the Joining UE. Further, information about the UEs that have joined the multicast service may be managed in a core network device such as the MME 40, the SGSN 42 and the BM-SC 44, for example. The information about the UEs that have joined the multicast service may be MBMS UE Context or the like defined by 3GPP, for example. In the case where the information about the UEs that have joined the multicast service is managed in another device, the BM-SC 44 may acquire the information about the UEs that have joined the multicast service from this another device.

When it is determined that Nx does not reach Nth, the management unit 12 allows the joining of the UE 30 that has sent the joining request message in Step S11 to the multicast service (S14). Information about the UE 30 is thereby managed in the core network device.

When it is determined that Nx reaches Nth in Step S12, the management unit 12 rejects the joining of the UE 30 that has sent the joining request message in Step S11 to the multicast service (S13). Then, the management unit 12 sends a reject message containing preferential information to the UE 30 (S15). The preferential information is information indicating approval for preferential joining of the communication terminal rejected to join the multicast service when requesting to join the multicast service next time. For example, the management unit 12 may allow the joining of the communication terminal that has sent the joining request message containing the preferential information to the multicast service preferentially to a communication terminal that has sent the joining request message not containing the preferential information.

In Step S12, the determination unit 11 may determine whether the number of IoT devices, as the number (Nx) of UEs already joining the multicast service, reaches the threshold (Nth) or not. At this time, the threshold (Nth) may be a smaller number than the maximum number of devices allowed to connect in a cell formed by a base station located in the E-UTRAN 31 or the UTRAN 33. This prevents cases where a device other than IoT devices cannot connect to the E-UTRAN 31 or the UTRAN 33 as a result that a large number of IoT devices connect to the E-UTRAN 31 or the UTRAN 33.

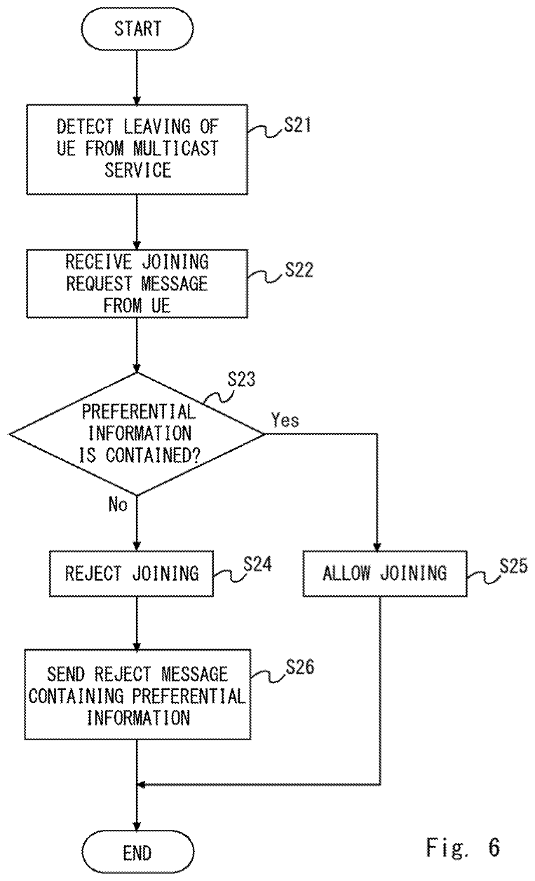

The flow of a determination process as to whether or not to allow joining a multicast service in the BM-SC 44 based on the preferential information is described hereinafter with reference to FIG. 6. FIG. 6 is based on the assumption that the number (Nx) of UEs already joining a multicast service reaches the predetermined threshold (Nth).

First, the management unit 12 detects that a UE that has been joining a multicast service has left the multicast service (S21). For example, when leaving the multicast service, the UE may send a message indicating the leaving to the BM-SC 44 by using control data or user data. Alternatively, a base station that is connected to the UE or the MME or the like that performs mobility management of the UE may send a message indicating that the UE has left the multicast service to the BM-SC 44. The management unit 12 may detect that the UE has left the multicast service by receiving the message indicating that the UE is to leave or has left the multicast service.

When the UE has left the multicast service in the state where Nx reaches Nth. Nx falls below Nth. Therefore, the management unit 12 can allow the joining of a new UE that requests to join the multicast service to the multicast service.

Next, the communication unit 13 receives a joining request message to a multicast service from the UE (S22). Then, the management unit 12 determines whether the joining request message contains the preferential information or not (S23). When the management unit 12 determines that the joining request message contains the preferential information, it allows the joining of the UE having sent the joining request message to the multicast service (S25).

When, in Step S23, the management unit 12 determines that the joining request message does not contain the preferential information, it rejects the joining of the UE having sent the joining request message to the multicast service (S24). The management unit 12 then sends a reject message containing the preferential information to the UE 30 (S26).

The timing when the UE that has received the preferential information sends the joining request message to the multicast service next time may be after the lapse of the next sleep time, for example.

As described above, the BM-SC 44 according to the second example embodiment determines whether or not to allow the joining of a UE that requests to join a multicast service based on the number of UEs already joining the multicast service. This prevents a number of UEs exceeding a predetermined threshold from joining the multicast service. Consequently, this prevents a core network device to perform registration processing or the like of information about a number of UEs exceeding a predetermined threshold. An increase in the processing load in the core network device is thereby avoided.

Further, the BM-SC 44 can send the preferential information to a UE that has requested to join a multicast service and has been rejected. This UE can send the preferential information when requesting to join a multicast service next time, which increases the possibility of being allowed to join the multicast service. This prevents the UE from being continuously rejected to join the multicast service.

In the above-described example, the program can be stored and provided to a computer using any type of non-transitory computer readable media. Non-transitory computer readable media include any type of tangible storage media. Examples of non-transitory computer readable media include magnetic storage media (such as flexible disks, magnetic tapes, hard disk drives, etc.), optical magnetic storage media (e.g., magneto-optical disks), Compact Disc Read Only Memory (CD-ROM), CD-R, CD-R/W, and semiconductor memories (such as mask ROM, Programmable ROM (PROM), Erasable PROM (EPROM), flash ROM, Random Access Memory (RAM), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

Note that the present disclosure is not limited to the above-described example embodiments and can be modified as appropriate without departing from the spirit and scope of the present disclosure. Further, the present disclosure may be implemented by combining the above-described example embodiments with one another.

The whole or part of the example embodiments disclosed above can be described as, but not limited to, the following supplementary notes.

### (Supplementary Note 1)

A multicast control device comprising:
a communication unit configured to receive a joining request message from a communication terminal to join a multicast service;
a determination unit configured to determine whether the number of communication terminals already joining the multicast service reaches a predetermined threshold; and
a management unit configured to reject joining of the communication terminal having sent the joining request message to the multicast service when it is determined that the number of communication terminals already joining the multicast service reaches the predetermined threshold.

### (Supplementary Note 2)

The multicast control device according to Supplementary Note 1, wherein
the communication unit sends preferential information indicating approval for preferential joining to the communication terminal rejected to join the multicast service, and
the management unit preferentially allows joining of the communication terminal having sent the joining request message containing the preferential information to the multicast service.

### (Supplementary Note 3)

The multicast control device according to Supplementary Note 2, wherein the management unit allows joining of the communication terminal having sent the joining request message containing the preferential information preferentially to a communication terminal having sent the joining request message not containing the preferential information.

### (Supplementary Note 4)

The multicast control device according to any one of Supplementary Notes 1 to 3, wherein the determination unit receives connection information of a communication terminal joining the multicast service from at least one base station connected to the communication terminal, and determines whether the number of communication terminals already joining the multicast service reaches a predetermined threshold based on the connection information.

### (Supplementary Note 5)

The multicast control device according to any one of Supplementary Notes 1 to 4, wherein, when connection of at least one communication terminal already joining the multicast service is removed in a state where the number of communication terminals already joining the multicast service reaches a predetermined threshold, the management unit allows joining of a new communication terminal to the multicast service.

### (Supplementary Note 6)

The multicast control device according to any one of Supplementary Notes 1 to 5, wherein
the communication terminal to join the multicast service is an IoT device, and
the number of IoT devices that can join the multicast service is a smaller number than the maximum number of devices allowed to connect in a cell formed by a base station.

### (Supplementary Note 7)

A multicast control method comprising:
receiving a joining request message from a communication terminal to join a multicast service;
determining whether the number of communication terminals already joining the multicast service reaches a predetermined threshold; and
rejecting joining of the communication terminal having sent the joining request message to the multicast service when it is determined that the number of communication terminals already joining the multicast service reaches the predetermined threshold.

### (Supplementary Note 8)

A program causing a computer to perform:
receiving a joining request message from a communication terminal to join a multicast service;
determining whether the number of communication terminals already joining the multicast service reaches a predetermined threshold; and
rejecting joining of the communication terminal having sent the joining request message to the multicast service when it is determined that the number of communication terminals already joining the multicast service reaches the predetermined threshold.

While the invention has been particularly shown and described with reference to example embodiments thereof, the invention is not limited to these example embodiments. It will be understood by those of ordinary skill in the art that various changes in form and details may be made therein without departing from the spirit and scope of the present invention as defined by the claims.

This application is based upon and claims the benefit of priority from Japanese patent application No. 2018-050090 filed on Mar. 16, 2018, the disclosure of which is incorporated herein in its entirety by reference.

### REFERENCE SIGNS LIST

10 MULTICAST CONTROL DEVICE
11 DETERMINATION UNIT
12 MANAGEMENT UNIT
13 COMMUNICATION UNIT
30 UE
31 E-UTRAN
32 UE
33 UTRAN
40 MME
41 MBMS-GW
42 SGSN
43 PGW
44 BM-SC
50 CONTENT PROVIDER
61 NETWORK INTERFACE
62 PROCESSOR
63 MEMORY

1. A multicast control device comprising:
at least one memory storing instructions, and
at least one processor configured to execute the instructions to:
receive a joining request message from a communication terminal to join a multicast service;
determine whether the number of communication terminals which have already joined the multicast service has reached a predetermined threshold; and
reject the joining of the communication terminal sending the joining request message to the multicast service when it is determined that the number of communication terminals which have already joined the multicast service has reached the predetermined threshold.

2. The multicast control device according to claim 1, wherein the at least one processor is further configured to execute the instructions to send preferential information indicating approval for preferential joining to the communication terminal which was rejected to join the multicast service, and
preferentially allow joining of the communication terminal sending a joining request message containing the preferential information to the multicast service.

3. The multicast control device according to claim 2, wherein the at least one processor is further configured to execute the instructions to allow joining of the communication terminal sending the joining request message containing the preferential information preferentially to a communication terminal sending the joining request message not containing the preferential information.

4. The multicast control device according to claim 1, wherein the at least one processor is further configured to execute the instructions to receive connection information of a communication terminal joining the multicast service from at least one base station connected to the communication terminal, and determine whether the number of communication terminals which have already joined the multicast service has reached a predetermined threshold based on the connection information.

5. The multicast control device according to claim 1, wherein, when connection of at least one communication terminal which has already joined the multicast service is removed in a state where the number of communication terminals which have already joined the multicast service has reached a predetermined threshold, the at least one processor is further configured to execute the instructions to allow joining of a new communication terminal to the multicast service.

6. The multicast control device according to claim 1, wherein
the communication terminal to join the multicast service is an IoT device, and
the number of IoT devices that can join the multicast service is a smaller number than the maximum number of devices allowed to connect in a cell formed by a base station.

7. A multicast control method comprising:
receiving a joining request message from a communication terminal to join a multicast service;
determining whether the number of communication terminals which have already joined the multicast service has reached a predetermined threshold; and
rejecting joining of the communication terminal sending the joining request message to the multicast service when it is determined that the number of communication terminals which have already joined the multicast service has reached the predetermined threshold.

8. A non-transitory computer readable medium storing a program causing a computer to perform:
receiving a joining request message from a communication terminal to join a multicast service;
determining whether the number of communication terminals which have already joined the multicast service has reached a predetermined threshold; and
rejecting joining of the communication terminal sending the joining request message to the multicast service when it is determined that the number of communication terminals which have already joined the multicast service has reached the predetermined threshold.
